(19) United States
(12) Patent Application Publication
(10) Pub. No.: US 2009/0188646 A1
(43) Pub. Date: Jul. 30, 2009

(54) Orientation Structure on Side Plates for Cooling Fins in Automotive Heater Core

(76) Inventor: Huixin Xu, Jiangyin (CN)

Correspondence Address: GLOBAL IP SERVICES, 7285 W. Eagle Court, Winton, CA, 95388, US

(21) Appl. No.: 12/359,288

(22) Filed: Jan. 24, 2009

(30) Foreign Application Priority Data
Jan. 30, 2008 (CN) 200810018990.6

(51) Int. Cl. B60H 1/00; F28F 7/00

(52) U.S. Cl. 165/41; 165/185

(57) ABSTRACT

This invention involves orientation structure on the side plate for cooling fins in automotive heater core, which belongs to the field of auto parts technology. The structure includes the side plates (5) and the cooling fins (7), characteristics of said structure are that there are two button protuberance (5.1) at both ends of the side plates (5) where the ends of cooling fins (7) are. This coordinative structure prevents the cooling fins from touching the header while increases the friction between the cooling fins and side plates, it keeps the cooling fins from partially melting, burning and dropping out during the brazing process, thus ensures the brazing quality.

### CROSS REFERENCE TO THE RELATED PATENT APPLICATION

This application claims the priority of the Chinese patent application No. 200810018990.6 filed on Jan. 30, 2008, which application is incorporated herein by reference.

### FIELD OF THE INVENTION

The invention involves an automotive heater core with an orientation structure on the side plate for cooling fins in automotive heater core. It belongs to the field of auto parts technology.

### BACKGROUND OF THE INVENTION

An automotive heater core is a radiator dissipating heat into the car cabin using cooling water from the engine, it includes: inlet pipe, outlet pipe, upper tank, bottom tank, header, tube, cooling fins and side plate. During the brazing process, as the materials used for cooling fins and header plate are different, they require different temperature of brazing, thus the cooling fins are often melted where they contact the header, which affects negatively the effective cooling area and the appearance and quality of the products, and often the cooling fins drop out during brazing.

### SUMMARY OF THE INVENTION

The purpose of this invention is to overcome the above shortages, and to provide an orientation structure on the side plate for cooling fins assembly in automotive heater core to prevent the partial melting, burning and the dropping out of the cooling fins during brazing.

The purpose is achieved through the orientation structure on the side plates for the cooling fins in an automotive heater core including side plate (5) and cooling fins. The side plate (5) has two button protuberances at both ends of the side plates to define the cooling fins without moving up and down.

By using this structure the cooling fins are kept from touching the header and the friction between the cooling fins and side plates is increased so that partial melting, burning out and dropping of the cooling fins are prevented to ensure brazing quality.

### BRIEF DESCRIPTION OF THE DRAWINGS

FIG. 1 shows the overall structure of the automotive heater core involved in this invention

FIG. 2 shows the two button protuberances at both ends of the side plates of the automotive heater core

FIG. 3 shows the positions of the 2 button protuberances on the side plates of the automotive heater core where the ends of the cooling fins are.

FIG. 4 is the breakdown of the positions of the 2 button protuberances on the side plates of the automotive heater core where the ends of the cooling fin are.

In the drawings: inlet pipe 1, outlet pipe 2, upper tank 3, header 4, side plate 5, tube 6, cooling fins 7, bottom tank 8, and button protuberance 5.1.

### DETAIL DESCRIPTION OF THE INVENTION

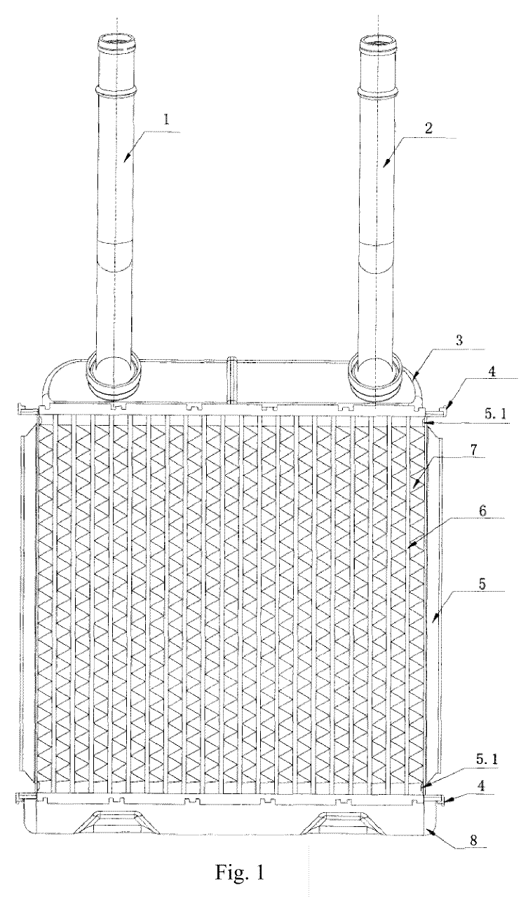

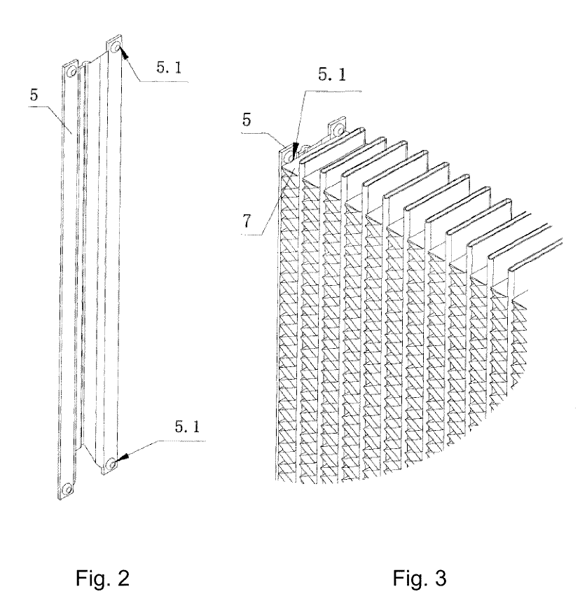

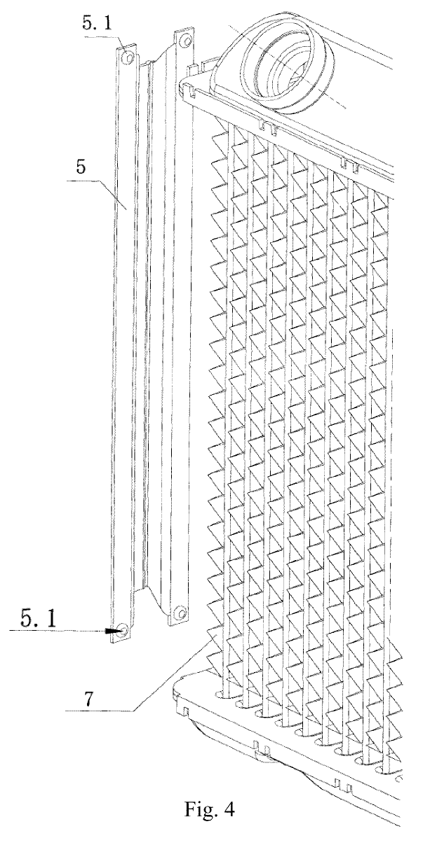

In reference to FIG. 1, an automotive heater core includes eight parts: inlet pipe 1, outlet pipe 2, upper tank 3, bottom tank 8, header 4, tube 6, cooling fins 7 and side plate 5. The side plate 5 has two button protuberances 5.1 at both ends of the side plates as indicated on the drawing. The cooling fins are between the two side plates. The cooling fins are defined by the button protuberances without moving up and down. Therefore, the cooling fins are kept from touching the header and to increase the friction between the cooling fins and side plates.

What is claimed is:

1. An orientation structure on side plates for cooling fins in automotive heater core comprising two side plates and cooling fins located between the two side plates, each side plate has two button protuberances at both ends thereof to keep the cooling fins from touching the header and to increase the friction between the cooling fins and side plates.
